(19) United States
(12) Patent Application Publication
(10) Pub. No.: US 2025/0236206 A1
(43) Pub. Date: Jul. 24, 2025

(54) GOLF CART WITH POWER CONSUMPTION MODES

(71) Applicant: Textron Inc., Providence, RI (US)

(72) Inventors: Gregory August Theodosakis, Martinez, GA (US); Russell William King, Evans, GA (US); Chris Aaron Bauman, Augusta, GA (US)

(73) Assignee: Textron Inc., Providence, RI (US)

(21) Appl. No.: 18/419,503

(22) Filed: Jan. 22, 2024

(51) Int. Cl. B60L 58/12; B60L 1/00; B60L 50/60

(52) U.S. Cl. CPC B60L 58/12; B60L 1/00; B60L 50/60; B60L 2200/22; B60L 2250/00; B60L 2260/40

(57) ABSTRACT

A golf cart includes a user interface, an electric motor, electric components, a battery, and processing circuitry. The battery provides power to the electric motor and the electric components. The processing circuitry operates the golf cart according to a first mode that permits operation of the electric motor to drive a tractive element without restricting operation of the electric components. The processing circuitry, responsive to receiving a user request at the user interface to transition the golf cart out of the first mode, transitions the golf cart into a second mode in which an amount of power discharged from the battery to at least one of the electric components is limited such that either (a) the at least one of the one or more electric components is restricted from receiving power from the battery or (b) the battery discharges a lesser amount of power than in the first mode.

### BACKGROUND

The present application relates to a control system for a vehicle. More specifically, the present application relates to a power system for a golf cart.

### SUMMARY

One embodiment of the present disclosure relates to a golf cart. The golf cart includes a user interface, an electric motor, one or more electric components, a battery, and processing circuitry. The battery is configured to provide electrical power to the electric motor and the one or more electric components. The processing circuitry configured to operate the golf cart according to a first mode that permits operation of the electric motor to drive a tractive element without restricting operation of the one or more of the electric components. The processing circuitry is also configured to, responsive to receiving a user request at the user interface to transition the golf cart out of the first mode, transition the golf cart into a second mode. In the second mode, an amount of power discharged from the battery to at least one of the one or more electric components is limited such that either (a) the at least one of the one or more electric components is restricted from receiving power from the battery or (b) the battery discharges a lesser amount of power than when the golf cart operates in the first mode.

In some embodiments, the processing circuitry is configured to, responsive to (a) not receiving the user request at the user interface to transition the golf cart out of the first mode and (b) an amount of elapsed time since previous operation of the golf cart reaching a threshold, transition the golf cart into the second mode. The processing circuitry is also configured to, responsive to (a) not receiving the user request at the user interface to transition the golf cart out of the first mode and (b) the amount of elapsed time since previous operation of the golf cart being less than the threshold, maintain the golf cart in the first mode.

In some embodiments, operating the golf cart according to the second mode includes permitting operation of the electric motor to drive the tractive element responsive to the control input while either (a) limiting the at least one of the one or more electric components from receiving power from the battery or (b) only allowing the at least one of the one or more electric components to receive the lower amount of power from the battery. In some embodiments, the processing circuitry is configured to prompt the user on the user interface to enter the second mode in response to detecting inactivity of the golf cart without requiring the user to navigate to a power saving selection interface with the user interface.

In some embodiments, the processing circuitry is configured to transition the golf cart out of the second mode and back into the first mode responsive to activity at the user interface or operation of the golf cart. In some embodiments, the user interface includes a digital touch screen configured to obtain the user request responsive to a user touching the digital touch screen.

In some embodiments, the processing circuitry is configured to receive a credential from a user via the user interface or a biometric sensor. The processing circuitry is also configured to restrict transitioning out of the first mode and into the second mode until the credential is authenticated.

In some embodiments, the user request is a first user request. The processing circuitry is configured to receive a second user request. The processing circuitry is also configured to, responsive to the second user request, transition the golf cart into a third mode where the electric motor is restricted from consuming power from the battery and at least one of the one or more electric components are allowed to consume power from the battery responsive to user commands to operate the one or more electric components.

Another embodiment of the present disclosure relates to a power control system of a vehicle. The power control system includes processing circuitry. The processing circuitry is configured to operate the vehicle according to a first mode that permits operation of an electric motor that consumes power from a battery to drive a tractive element without restricting operation of one or more electric components of the vehicle. The processing circuitry is also configured to, responsive to receiving a user request at a user interface to transition the vehicle out of the first mode, transition the vehicle into a second mode in which an amount of power discharged from the battery to at least one of the one or more electric components is limited such that either (a) the at least one of the one or more electric components is restricted from receiving power from the battery or (b) the battery discharges a lesser amount of power than when the golf cart operates in the first mode.

In some embodiments, the processing circuitry is configured to, responsive to (a) not receiving the user request at the user interface to transition the vehicle out of the first mode and (b) an amount of elapsed time since previous operation of the vehicle reaching a threshold, transition the vehicle into the second mode. The processing circuitry is configured to, responsive to (a) not receiving the user request at the user interface to transition the vehicle out of the first mode, and (b) the amount of elapsed time since previous operation of the vehicle being less than the threshold, maintain the vehicle in the first mode.

In some embodiments, operating the vehicle according to the second mode includes permitting operation of the electric motor to drive the tractive element responsive to the control input while either (a) limiting the at least one of the one or more electric components from receiving power from the battery or (b) only allowing the at least one of the one or more electric components to receive the lower amount of power from the battery. In some embodiments, the processing circuitry is configured to prompt the user on the user interface to enter the second mode in response to detecting inactivity of the vehicle without requiring the user to navigate to a power saving selection interface with the user interface.

In some embodiments, the processing circuitry is configured to transition the vehicle out of the second mode and back into the first mode responsive to activity at the user interface or operation of the vehicle. In some embodiments, the user interface includes a digital touch screen configured to obtain the user request responsive to a user touching the digital touch screen.

In some embodiments, the processing circuitry is configured to receive a credential from a user via the user interface or a biometric sensor. The processing circuitry is also configured to restrict transitioning out of the first mode and into the second mode until the credential is authenticated.

In some embodiments, the user request is a first user request. The processing circuitry is configured to receive a second user request. The processing circuitry is configured to, responsive to the second user request, transition the vehicle into a third mode where the electric motor is restricted from consuming power from the battery and at least one of the one or more electric components are allowed to consume power from the battery responsive to user commands to operate the one or more electric components.

Yet another embodiment of the present disclosure relates to a method of transitioning a vehicle between, and operating the vehicle according to, different modes of power consumption. The method includes operating the vehicle according to a first mode that permits operation of an electric motor that consumes power from a battery to drive a tractive element without restricting operation of one or more electric components of the vehicle that consume power from the battery. The method also includes, responsive to receiving a user request at a user interface to transition the vehicle out of the first mode, transitioning the vehicle into a second mode in which an amount of power discharged from the battery to at least one of the one or more electric components is limited such that either (a) the at least one of the one or more electric components is restricted from receiving power from the battery or (b) the battery discharges a lesser amount of power than when the golf cart operates in the first mode.

In some embodiments, the method includes, responsive to (a) not receiving the user request at the user interface to transition the vehicle out of the first mode and (b) an amount of elapsed time since previous operation of the vehicle reaching a threshold, transitioning the vehicle into the second mode. The method also includes, responsive to (a) not receiving the user request at the user interface to transition the vehicle out of the first mode and (b) the amount of elapsed time since previous operation of the vehicle being less than the threshold, maintaining the vehicle in the first mode.

In some embodiments, operating the vehicle according to the second mode includes permitting operation of the electric motor to drive the tractive element responsive to the control input while either (a) limiting the at least one of the one or more electric components from receiving power from the battery or (b) only allowing the at least one of the one or more electric components to receive the lower amount of power from the battery. In some embodiments, the method includes prompting the user on the user interface to enter the second mode in response to detecting inactivity of the vehicle without requiring the user to navigate to a power saving selection interface with the user interface.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a block diagram of a power system of the vehicle of FIG. 1, according to an exemplary embodiment.

FIG. 5 is a flow diagram of a process implemented by the power system of FIG. 4, according to an exemplary embodiment.

FIG. 6 is a block diagram of the power system of FIG. 4, according to an exemplary embodiment.

FIG. 7 is a flow diagram of a process for transitioning the vehicle of FIG. 1 between different power modes and operating the vehicle according to the different power modes, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a power system that is configured to control discharge of power from a battery to a prime mover (e.g., an electric motor) and one or more other devices of the vehicle such as accessories. The vehicle includes a digital touch device that allows for control over vehicle accessory power management. The power system is configured to allow the user to command entry into a power saving mode via touching a screen of the digital touch device. The power system is also configured to allow the user to exit the power saving mode via touching the screen of the digital touch device. The power system is also configured to allow entry and exiting of accessory power mode without need of access control device such as physical keys. The power system can also implement additional security via fingerprint based access control in addition to the touching of the screen of the digital touch device to transition between different modes.

The power system allows the user to interact with the screen of the digital touch device to cause the vehicle systems to enter inactivity or power saving modes while the system is still on. Exiting the power saving mode can be achieved by the user via prompting the digital touch device by touch of the screen to wakeup the vehicle system. When in the power saving mode, the vehicle is in a state of inactivity with minimal devices energized to keep the system operational where devices such as the accessories are turned off.

The power system also provides an accessory-only mode such that it is not reliant on additional vehicle inputs or access controls. Advantageously, the power system can allow vehicle accessory power on-demand. The power system can also employ additional authorization or authentication (e.g., fingerprint scanning) to integrate vehicle access control into power management of the accessories of the vehicle. The power system may be used in concert with pre-existing sleep and wakeup methods of vehicle timeout and vehicle control interactions. Advantageously, the power system provides an easy action such as a touch to enter and exit the power saving mode. It should be understood that while the power system is described with reference to an electric golf cart herein, the power system may also be applicable to other electric vehicles such as other small vehicles, utility vehicles, commercial vehicles, low-speed vehicles (LSVs), and/or vehicles that do not use electrical power as a primary energy source to transport.

### Overall Vehicle

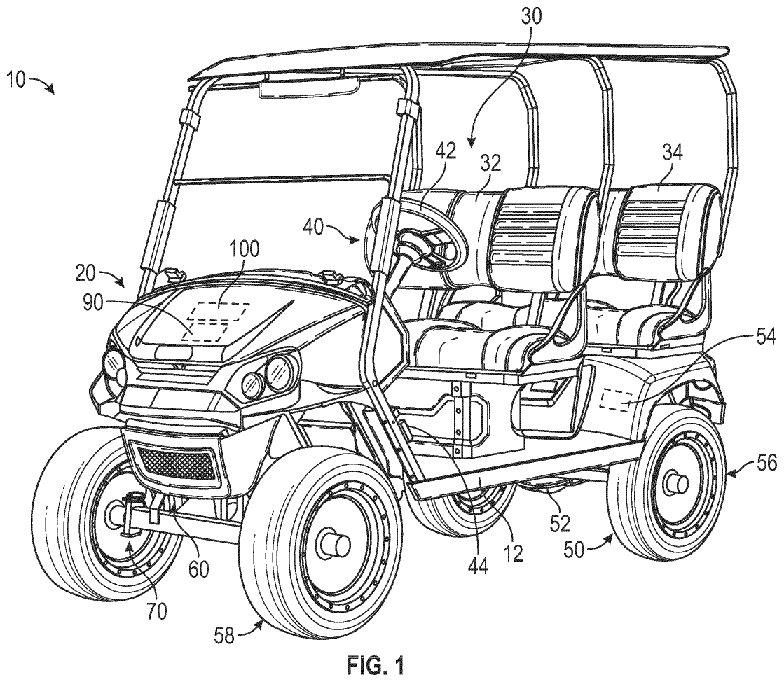

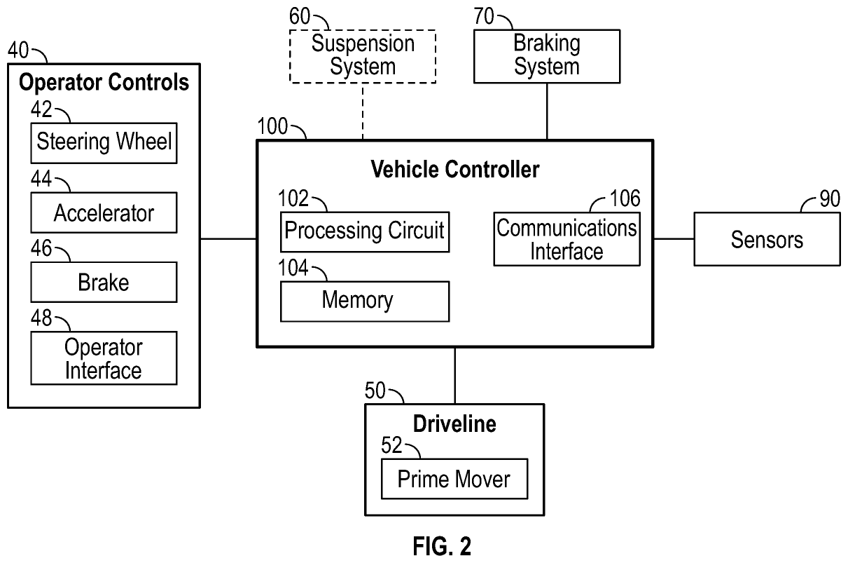

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

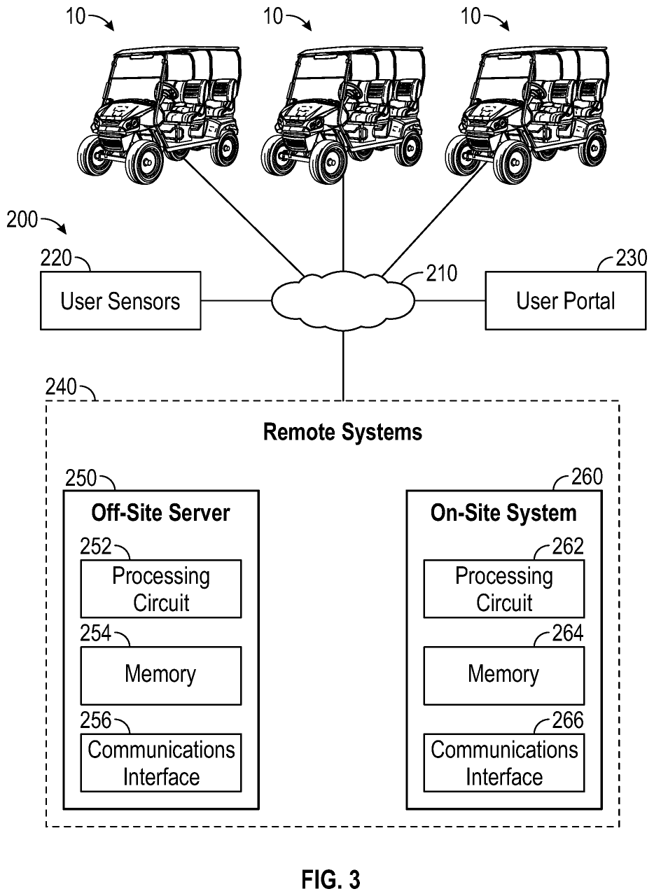

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Power System

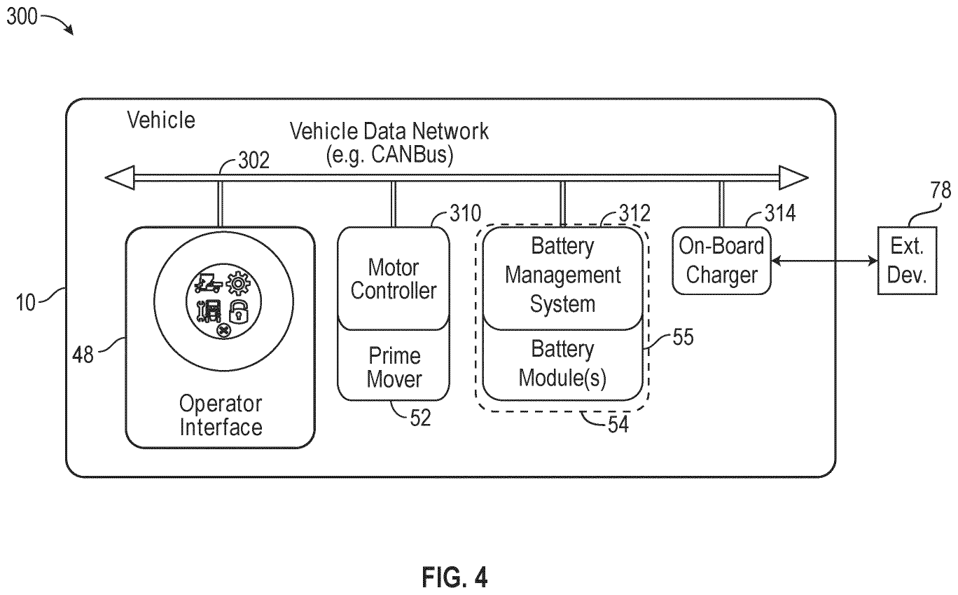

Referring to FIGS. 4-7, the vehicle 10 is equipped with a power system 300 (e.g., a power distribution system, a control system, a power control system, a power management system, an electrical system, etc.), according to an exemplary embodiment. The power system 300 may transition between different modes to conserve power of one or more batteries, shown as battery modules 55, of the energy storage 54 of the vehicle 10 responsive to a touch at a screen of a digital touch device.

Referring particularly to FIG. 4, the power system 300 of the electric vehicle 10 includes a communications bus 302 (e.g., CAN bus), the operator interface 48 (e.g., an interactive touch screen, a display screen and corresponding button set, the digital touch device, etc.), a motor controller 310, the prime mover 52 (e.g., an electric motor, a traction motor, etc.), a battery management system (“BMS”) 312, and one or more battery modules 55 (e.g., battery cells, battery units, batteries, power storage devices, etc.). The power system 300 also includes an on-board charger 314 that is configured to exchange electrical energy with an external device 78. For example, the external device 78 may be an external source of power (e.g., a battery, a main power source, a wall power source, etc.) that supplies electrical energy to the on-board charger 314 which is used to charge the battery modules 55 (e.g., by providing electrical energy from the on-board charger 314 to the battery modules 55 through the battery management system 312). In an exemplary embodiment, the power system 300 also includes one or more accessories (e.g., a GPS, an infotainment device, speakers, etc.) that are configured to consume electrical energy from the battery modules 55 through the battery management system 312. The battery management system 312 is configured to operate the battery modules 55 to discharge electrical power to various electrical components of the vehicle 10 according to a selected or currently active state (e.g., a mode of operation). In some embodiments, the external device 78 includes an electrical power sink (e.g., a phone charging interface, a charging interface) and the battery management system 312 and the on-board charger 314 are configured to discharge electrical power from the battery modules 55 to the external device 78.

The power system 300 can also include the vehicle controller 100 configured to communicate with any of the operator interface 48, the motor controller 310, the battery management system 312, and the on-board charger 314 via the communications bus 302. The vehicle controller 100 is configured to implement one or more of the control features of the power system 300 as described herein. In some embodiments, the power control techniques and state transitions of the power system 300 as described herein are performed in a distributed manner across different controllers or processing units that are communicably coupled with the communications bus 302 (e.g., the vehicle controller 1000, the motor controller 31100, the battery management system 312, etc.).

The motor controller 310 may be a local or lower level controller that is configured to receive communications on the communications bus 302 (e.g., from the accelerator 44, the brake 46, from the operator interface 48 or a corresponding controller or module of the operator interface 48, from the vehicle controller 100, etc.) and operate the prime mover 52 according to the communications. In some embodiments, the motor controller 310 is configured to receive communications from a fleet management system and operate or adjust operation of the prime mover 52 based on the communications from the fleet management system. The prime mover 52 may be implemented to drive tractive elements of the vehicle 10 through a driveline, or may be implemented as multiple electric motors each corresponding to different tractive elements of the vehicle 10. It should be understood that any configuration of the driveline are intended to be within the scope as described herein, and that the motor controller 310 and the prime mover 52 may represent a single pair of motor controllers and prime movers, or may represent multiple motor controllers and electric motors that are communicably coupled on the communications bus 302.

The power system 300 is configured to operate the vehicle 10 according to different power modes or states. For example, the power system 300 is configured to operate the vehicle 10 according to a normal mode or state (e.g., a first mode) where discharge of electrical energy from the battery modules 55 is unrestricted. The power system 300 is also configured to operate the vehicle 10 according to a low power state or a low power mode (e.g., a power saving mode, a power efficient mode, a second mode, etc.) where discharge of electrical energy from the battery modules 55 is limited (e.g., certain electrical components of the vehicle 10 are placed into a low-power consumption state where the devices consume less electrical power than in the normal mode or state, certain electrical components of the vehicle 10 are restricted or limited from receiving power such that the certain electrical components are effectively disabled while the vehicle 10 is in the low power state or low power more, etc., or any combination thereof). In the low power state or mode, one or more accessories of the vehicle 10 may be disabled such that life of the battery modules 55 is extended and extraneous power sinks are limited from draining the battery modules 55.

The power system 300 is also configured to operate the vehicle 10 according to an accessory only mode, where only certain accessories of the vehicle 10 are activated. Activation or de-activation of electrical devices of the vehicle 10 (e.g., certain accessories) may include allowing or restricting respective consumption of electrical energy from the battery modules 55. For example, an active device on the vehicle 10 may be a device that is unrestricted in its power consumption (within the active device's ratings or power consumption capabilities), or be a device that is currently consuming some amount of electrical energy, whereas a de-activated electrical device is a device that is restricted in its power consumption (e.g., completely restricted from consuming any power from the battery modules 55 or limited in an amount of power consumption that the device is allowed to consume). Each of the different states or modes as described herein may include a different mapping of which electrical components or devices of the vehicle 10 are to be activated or de-activated when the vehicle 10 is transitioned into the different states or modes. The battery management system 312 may include a power distributor that is configured to selectively allow discharge of electrical energy from the battery modules 55. The activation and de-activation of certain electrical devices or components of the vehicle 10 (when transitioning the vehicle 10 into or out of the different states or modes) can be achieved by operation of the power distributor of the battery management system 312 such that the battery modules 55 are limited from discharging electrical power to de-activated devices or allowed to discharge electrical energy to activated devices in accordance with a currently selected state or mode.

Advantageously, the transition of the vehicle 10 between the different modes or states can be initiated or commanded by the user via the operator interface 48. For example, certain vehicles may use a time-out feature where, if the vehicle 10 is not operated or used for a certain amount of time, the vehicle automatically transitions into a low power state in order to preserve battery life by limiting power consumption by systems not currently used. The power system 300 advantageously facilitates both (1) a time-out feature such that the vehicle 10 is automatically transitioned into the low power state, and (2) a manual control such that the operator of the vehicle 10 can command the vehicle 10 between different states or modes by interacting with the operator interface 48. The power system 300 may fuse both of these controls in order to extend battery life and improve travel range of the vehicle 10 (e.g., improve distance that the vehicle 10 can travel by limiting power consumption by accessories or other electrical devices or systems other than the prime mover 52).

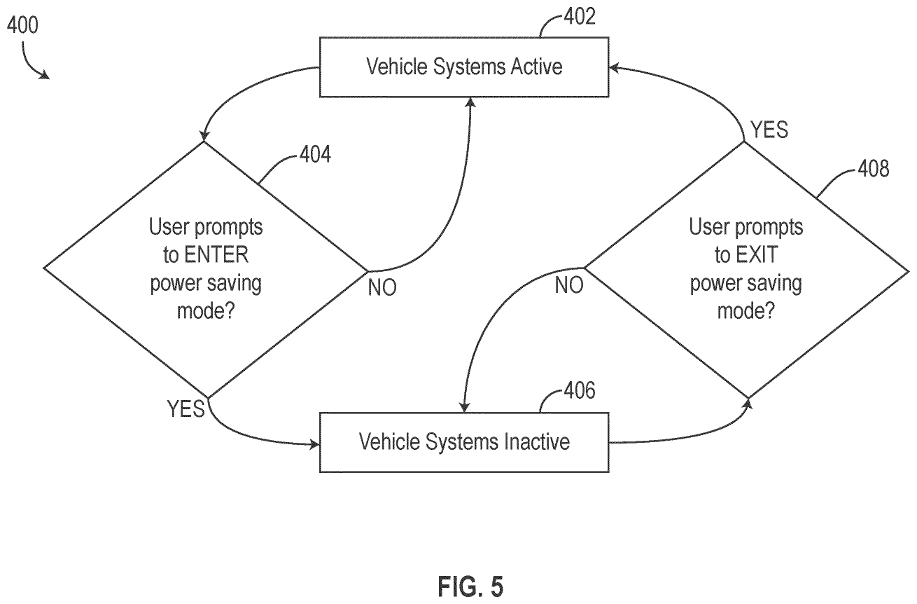

Referring to FIG. 5, a flow diagram of a process 400 for transitioning the vehicle 10 between different states (e.g., the normal mode or state and the low power mode or state) includes steps 402-408. The process 400 is performed by the power system 300, or more specifically, by the vehicle controller 100. The process 400 includes activating the vehicle 10 such that the motor controller 310, the prime mover 52, the on-board charger 314, the accessories, etc., are all active (step 402). When all systems of the vehicle 10 are active at step 402, the vehicle 10 operates in an unrestricted mode or state and the battery modules 55 are operated to discharge electrical energy without restriction.

The process 400 also includes prompting the user or the user prompting the vehicle 10 to enter the vehicle 10 into a power saving mode (step 404). Step 404 can be performed by operating the operator interface 48 to display a prompt or user interface on a display screen that provides a point of interaction for the user (e.g., a button or icon). In some embodiments, a power saving mode prompt is displayed at the operator interface 48 when the vehicle 10 stops, is put into park, etc. without requiring the user to navigate to a power saving selection interface. If the user provides, via the operator interface 48, a command that the vehicle 10 should enter the power saving mode (e.g., the low power mode or state) (step 404, “YES”), process 400 proceeds to step 406. If the user does not provide the command to transition the power saving mode (step 404, “NO”), the process 400 continues at step 402 (e.g., the vehicle 10 is operated in the normal mode or state where the vehicle systems are active and unrestricted in power consumption). Step 404 may be performed simultaneously with step 402 (e.g., while the vehicle 10 is operating in the normal mode).

The process 400 includes inactivating one or more vehicle systems (step 406). Step 406 is performed responsive to the user prompting to enter the vehicle 10 in the power saving mode (step 404, “YES”). When the vehicle 10 is operated in the power saving mode, one or more electrical components of the vehicle 10 are de-activated so that they do not consume electrical energy. For example, accessories of the vehicle 10 may be de-activated but the vehicle 10 may be allowed to be driven by operating the prime mover 52 using electrical energy from the battery modules 55. As another example, all power to electrically operated systems of components of the vehicle 10 is disabled until the power saving mode is turned off.

The process 400 includes prompting the user or the user prompting the vehicle 10 to exit the power saving mode (step 408). Step 408 can be performed by operating the operator interface 48 to display a prompt or user interface on a display screen that provides a point of interaction for the user (e.g., a button or icon). In some embodiments, a power saving exit prompt is displayed at the operator interface 48 when the vehicle 10 senses the user entering the vehicle 10, when the user touches the operator interface 48, the user pressing on the accelerator 44, etc. while the vehicle 10 is in the power saving mode. If the user provides, via the operator interface 48, a command that the vehicle 10 should exit the power saving mode (e.g., the low power mode or state) (step 408, “YES”), process 400 returns to step 402 and operates the vehicle 10 in the normal mode. If the user does not provide the command to transition out of the power saving mode (step 408, “NO”), the process 400 continues at step 406 (e.g., the vehicle 10 remains in the power saving mode). Advantageously, the process 400 described herein with reference to FIG. 5 allows the user to manually operate the operator interface 48 (e.g., a touch screen of the operator interface 48) to transition the vehicle 10 into the power saving state as desired. While described as a touch screen, the vehicle 10 may be transitioned into and out of the power saving mode via a button, switch, a toggle, or other mechanical or physical interface.

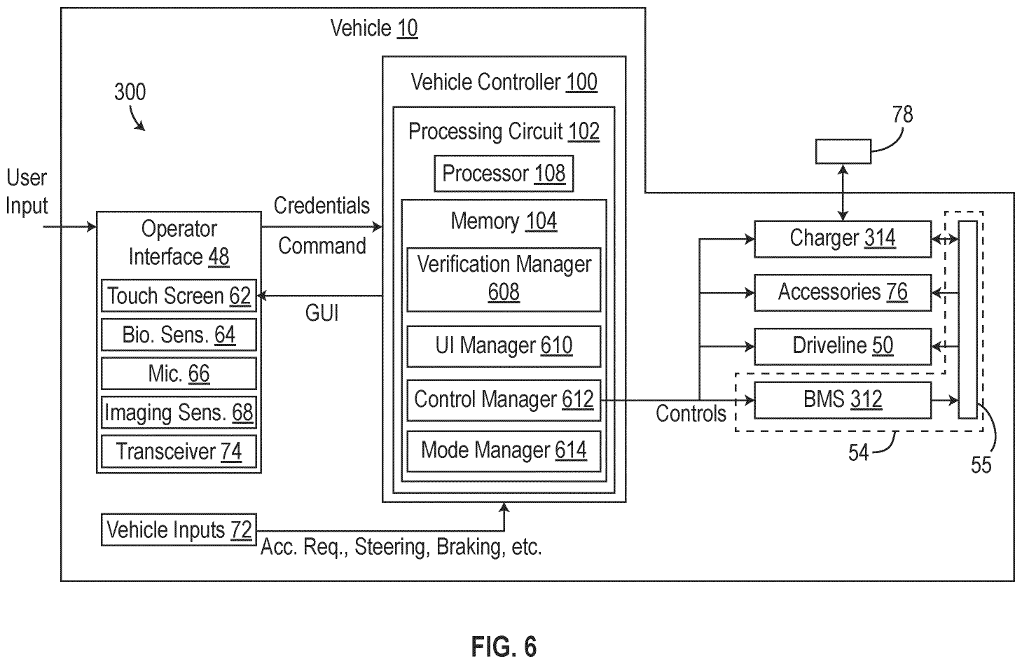

Referring to FIG. 6, a diagram illustrates the power system 300 in greater detail. The power system 300 includes the operator interface 48, the vehicle controller 100, the driveline 50, the charger 314, one or more accessories 76 (e.g., accessory electrical devices or systems), the BMS 312, and the battery modules 55. The operator interface 48 includes a touch screen 62, and may also include one or more of a biometric sensor 64, a microphone 66, an imaging sensor 68, or a wireless transceiver 74. The touch screen 62 of the operator interface 48 is configured to display one or more user interfaces including buttons, textual indications, selectable icons, etc., in order to facilitate obtaining user inputs or commands from the user regarding which of multiple modes to transition the vehicle 10 between. The touch screen 62 is also configured to obtain user inputs including but not limited to, credentials, UI navigation inputs, state transitions, etc. The biometric sensor 64 is configured to obtain biometric credentials and may include a fingerprint scanner, an eye scanner, etc. The microphone 66 is configured to obtain audio data spoken by the user (e.g., an aural credential). The imaging sensor 68 (e.g., a camera) is configured to obtain visual credentials and may obtain image data for processing by the vehicle controller 100 to implement facial recognition as a form of credentials. The transceiver 74 can be any wireless radio, receiver, emitter, or transceiver configured to communicate with a user device (e.g., a smartphone) via Bluetooth, LoRA, Zigbee, near field communications (“NFC”), radio frequency identification (“RFID”) tags, etc., in order to wirelessly obtain credentials from a user device (e.g., a personal computer device such as a smartphone, tablet, smart watch, badge, etc.). The vehicle controller 100 may also receive data from vehicle inputs 72. The vehicle inputs 72 include any devices through which the user operates the vehicle 10 such as the operator controls 40 (e.g., the steering wheel 42, the accelerator 44, the brake 46, etc.).

The processing circuit 102 of the vehicle controller 100 may be implemented in a single controller or multiple distributed controllers throughout the vehicle 10. For example, any of the functions of the vehicle controller 100 as described herein can be performed by a fleet management system, the motor controller 310, a microcontroller or processor of the operator interface 48, local controllers or processing units of any components of the driveline 50 of the vehicle 10, etc., or any combination thereof.

The processing circuit 102 of the vehicle controller 100 includes a processor 108 and the memory 104. The memory 104 includes a verification manager 608, a user interface (“UI”) manager 610, a control manager 612, and a mode manager 614. The verification manager 608 may be optional and is configured to restrict or limit transitioning of the vehicle 10 between the different modes or states until the user has provided credentials that are authorized by the verification manager 608. The UI manager 610 is configured to operate the touch screen 62 of the operator interface 48 in order to display various UIs that indicate a current mode or state that the vehicle 10 is in, and provide selectable icons that, when pressed by the user, transition the vehicle 10 between the different modes. In some embodiments, the UI manager 610 is also configured to prompt the user to enter credentials (e.g., a typed personal identification number, a password, etc.) via the touch screen 62, or to enter credentials via a different modality such as by the biometric sensor 64, the microphone 66, the imaging sensor 68, or the transceiver.

The verification manager 608 is configured to obtain the credentials provided by the user and determine if the credentials are authorized to transition the vehicle 10 between the different modes. For example, the verification manager 608 may include a database that stores information regarding multiple users and their corresponding credentials. The verification manager 608 is configured to, responsive to receiving the credentials from the operator interface 48, check the database to determine if the credentials match stored credentials. If the credentials entered by the user match stored credentials and the user has sufficient authorization level or clearance to transition the vehicle 10 between the different modes, the verification manager 608 can notify the control manager 612 and the mode manager 614 that the user is authorized to transition between the different modes.

The control manager 612 and the mode manager 614 are configured to use a command obtained from the user via the operator interface 48 and transition the vehicle 10 between the different modes in accordance with the command. The control manager 612 and the mode manager 614 may restrict transition of the vehicle 10 between the different modes in accordance with the command until the user enters credentials that are verified and authorized by the verification manager 608. The mode manager 614 may store information and settings regarding different modes that the vehicle 10 can be transitioned between. For example, the mode manager 614 may store information regarding which devices or components of the vehicle 10 (e.g., which of the accessories 76, the prime mover 52, etc.) should be disabled or limited from consuming power from the battery modules 55 while in the low power mode.

The mode manager 614 may also include a timer that is configured to monitor an amount of elapsed time since the user interacts with the operator interface 48 or the vehicle inputs 72. The timer may be reset every time the user interacts with the operator interface 48 or the vehicle inputs 72. In some embodiments, the mode manager 614 is configured to compare the amount of elapsed time to a corresponding threshold and, responsive to the amount of elapsed time being substantially equal to or exceeding the threshold, transitioning the vehicle 10 out of the normal mode (e.g., the unrestricted mode) and into the low power mode where one or more devices (e.g., the accessories 76) of the vehicle 10 are disabled (i.e., without requiring the user to transition the vehicle 10 into the low power mode). In some embodiments, the mode manager 614 is configured to perform the time-based transition of the vehicle 10 out of the normal mode and into the low power mode simultaneously with manual command-based control of the vehicle 10 to transition between the modes (e.g., based on inputs obtained from the touch screen 62). In some embodiments, the mode manager 614 is configured to perform the time-based automatic transition of the vehicle 10 into the low power mode only when the vehicle 10 is in the normal mode (e.g., the unrestricted mode). For example, once the vehicle 10 is in the low power mode, transition of the vehicle 10 out of the low power mode may be achieved by the user via providing commands at the operator interface 48.

The control manager 612 is configured generate controls for any of the BMS 312, the driveline 50, the accessories 76, or the charger 314 in accordance with the mode that is currently activated by the mode manager 614. When the vehicle 10 is in the normal mode, the vehicle 10 and the systems and sub-systems thereof (e.g., the charger 314, the accessories 76, the driveline 50, the BMS 312, the operator interface 48, etc.) are active and operate in an unrestricted manner. In particular, the accessories 76 are not limited in an amount or rate of power consumption from the battery modules 55. The control manager 612, when the vehicle 10 is in the normal mode, is configured to obtain control inputs from the vehicle inputs 72 (e.g., acceleration requests, steering operations, braking operations, etc.) and operate the driveline 50 and the BMS 312 such that the driveline 50 consumes power from the battery modules 55 to implement the control inputs. Similarly, in the normal mode, the control manager 612 may receive inputs from the operator interface 48 (e.g., commands via the touch screen 62) to control or adjust operation of the accessories 76, and generates controls for the accessories 76 in accordance with the inputs to perform requested functions, regardless of a corresponding amount of power or electrical energy consumed by the accessories 76 from the battery modules 55 when performing the requested functions.

When the vehicle 10 is transitioned into the low power mode, either by the automatic time-based control or responsive to receiving a command from the user (with authorized credentials), the mode manager 614 activates the low power mode, and the control manager 612 implements the low power mode. The control manager 612 can implement the low power mode by receiving inputs from the operator interface 48 to operate one or more devices of the vehicle 10, but limit the controls provided to restricted devices as indicated by the low power mode. For example, in the low power mode, the control manager 612 may limit operation of the accessories 76 of the vehicle 10 in order to conserve power. If the user provides inputs via the operator interface 48 to control operation of the accessories 76, the control manager 612 can limit operation of the accessories 76 by not providing controls to the accessories 76 responsive to the inputs. In another example, the low power mode is implemented by the control manager 612 providing instructions or controls to the BMS 312 to limit discharge of power from the battery modules 55 to one or more of the devices identified in the low power mode (e.g., by the mode manager 614) as being disabled in the low power mode. In this example, even if the user requests or commands operation of a restricted device (e.g., the accessories 76), the restricted devices are limited in operation due to the BMS 312 restricting the discharge of electrical energy to the restricted devices. It should be understood that the devices of the vehicle 10 that are disabled or restricted in the low power mode may include the accessories 76 (e.g., a GPS system, music speakers, lighting devices, telematics or telemetry systems, communications systems, monitoring systems, pumps, cooling systems, heating systems, etc.) or a subset of the accessories 76. The devices that are disabled or restricted in the low power mode may also include external power chargers such as cell phone chargers.

In some embodiments, in one or more low power modes, the vehicle 10 is still be allowed to transport or be driven. For example, the control manager 612 may still receive control requests from the vehicle inputs 72 and operate the driveline 50 to implement the control requests (e.g., steering, driving, and braking operations). In some embodiments, the control manager 612 operates the driveline 50 (e.g., by providing controls to the components of the driveline 50 in accordance with the control requests provided at the vehicle inputs 72) in an unrestricted manner. In some embodiments, transportation of the vehicle 10 is still allowed in the low power mode, but a top speed of the vehicle 10 is limited in order to conserve power. For example, the control manager 612 can provide instructions to the BMS 312 to allow discharge of electrical energy from the battery modules 55 to the driveline 50, but at a reduced rate as compared to the normal mode.

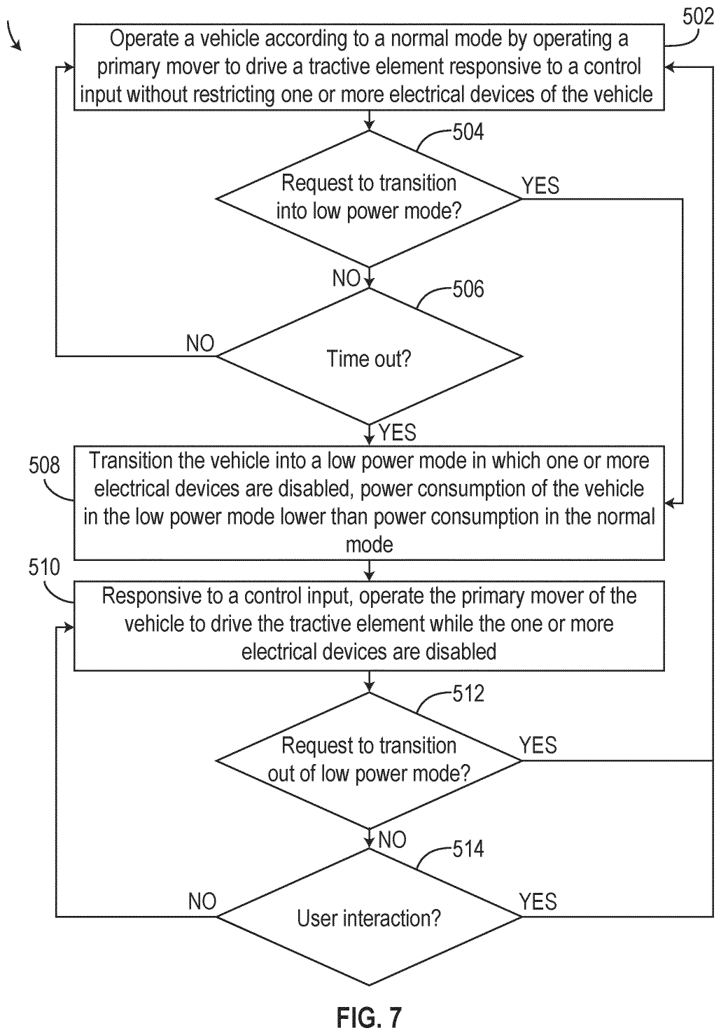

Referring to FIG. 7, a flow diagram of a process 500 for operating a vehicle (e.g., the vehicle 10, a golf cart, a UTV, a turf mower, etc.) according to and transitioning between normal and low power modes includes steps 502-514. The process 500 can be implemented by the power system 300 of the vehicle 10 as described in greater detail above with reference to FIGS. 4-6. In particular, the process 500 is implemented by the vehicle controller 100, a power distribution system, etc.

The process 500 includes operating a vehicle according to a normal mode by operating a prime mover to drive a tractive element responsive to a control input without restricting one or more electrical devices of the vehicle (step 502). Step 502 may include receiving control inputs, accessory control requests, etc., and operating any system of the vehicle without restricting any electrical devices of the vehicle. In the normal mode, the vehicle is operated responsive to user requests or commands without limiting or disabling any of the systems. The electrical devices are able to consume electrical power from battery modules of the vehicle as needed. Step 502 may be performed by the vehicle controller 100, or more generally, by the power system 300.

The process 500 includes determining if a request to transition the vehicle into a low power mode is received (step 504). The request to transition the vehicle into the low power mode may be received from the operator interface 48 (e.g., the touch screen 62). In some embodiments, step 504 also includes obtaining a credential from the user. The credential may be a personal identification number, a password, a biometric, etc. Step 504 may also include verifying or authenticating the credential by checking if the credential matches with an approved credential of an approved user. In some embodiments, in response to receiving the request to transition into the low power mode (step 504, “YES”), process 500 proceeds to step 508. In some embodiments, if credential verification is required, process 500 proceeds to step 508 responsive to both receiving the request to transition into the low power mode, and the credential being verified (step 504, “YES”). If the user does not request to transition into the low power mode, or credential verification is required in addition to the request and the credential is unauthorized (step 504, “NO”), process 500 proceeds to step 506.

The process 500 includes determining if a threshold amount of time has elapsed since previous activity at the vehicle (step 506) (e.g., the vehicle 10 being driven, the operator interface 48 being interacted with, etc.). Step 506 may be optional. Step 506 is performed in order to implement both manual control of the vehicle between different modes and to also implement a sleep function where the vehicle is automatically transitioned into the low power mode after a sufficient period of inactivity and without requiring user input to perform the transition. In response to the threshold amount of time elapsing since the previous activity at the vehicle (step 506, “YES”), process 508 proceeds to step 508. If the threshold amount of time has not elapsed since the previous activity at the vehicle (e.g., the vehicle has not timed out), process 500 returns to step 502 (step 506, “NO”).

The process 500 includes transitioning the vehicle into a low power mode in which one or more electrical devices are disabled, where power consumption of the vehicle in the low power mode is less than power consumption of the vehicle in the normal mode (step 508). Step 508 may be implemented by the control manager 612 and the mode manager 614. Step 508 can include controlling operation of the BMS 312 so that certain electrical devices of the vehicle are limited form consuming electrical power (e.g., one or more accessories of the vehicle 10, the prime mover 52, etc.).

The process 500 includes, responsive to a control input, operating the prime mover of the vehicle to drive the tractive element while the one or more electrical devices are disabled (step 510). Step 510 may include operating the prime mover in a limited manner to consume less electrical energy than in the normal mode. Step 510 is implemented such that the vehicle may be transported even when in the low power mode (e.g., when accessories of the vehicle are disabled). In some embodiments, the prime mover is also disabled in one or more low power modes (e.g., a first lower power mode where the prime mover is enabled, a second low power mode where the prime mover is disabled, etc.)

The process 500 includes determining if a request to transition the vehicle out of the low power mode is received (step 512). Step 512 is implemented similarly to step 504 and may include the requirement for the user to enter credentials that must be verified before allowing transition of the vehicle out of the low power mode. Responsive to receiving the request to transition out of the low power mode (step 512, “YES”), process 500 returns to step 502 where the vehicle (e.g., the vehicle 10) is operated according to the normal or unrestricted mode. If the vehicle controller 100 does not receive a request to transition out of the low power mode (step 512, “NO”), process 500 proceeds to step 514.

The process 500 includes identifying if any user interaction occurs at the vehicle (step 514). In some embodiments, if user interaction occurs at the vehicle 10, the vehicle controller 100 automatically transitions out of the low power mode. User interactions can be detected such as movement of a door of the vehicle 10, movement of a seat of the vehicle 10, depression of a pedal, entry of a key, etc. Step 514 may be similar to step 506 but instead of monitoring an amount of elapsed time since last activity at the vehicle 10, step 514 includes monitoring current activity, and if a threshold level of activity at the vehicle 10 is detected, automatically transitioning the vehicle 10 out of the low power mode. Responsive to user interaction being detected (step 514, “YES”), process 500 returns to step 502. If user interaction is not detected (step 514, “NO”), process 500 returns to step 510 and continues operating the vehicle 10 in the low power mode. It should be understood that steps 506 and 514 may be optional, and whether or not the vehicle controller 100 implements the “sleep” and “wake up” operations described with reference to steps 506 and 514 respectively, may be a user selectable value that can be set by the user through interaction with the operator interface 48 (e.g., the touch screen 62). For example, the user may enable or disable automatic sleep and wake up features by adjusting settings via the touch screen 62 and providing credentials sufficient to change settings of the vehicle 10.

Referring again to FIGS. 4-6, the vehicle controller 100 may also be configured to implement an accessories mode (e.g., an accessory only mode, a third mode, etc.). The mode manager 614 may store information regarding the accessories mode and which components of the vehicle 10 are enabled (the accessories 76) and which components of the vehicle 10 are disabled (e.g., the driveline 50) when the accessories mode is active. The accessories mode may be activated similarly to the manual transition of the vehicle 10 as described herein with reference to the normal or unrestricted mode and the low power or power savings mode. For example, the UI manager 610 may operate the touch screen 62 to display multiple icons including a first icon corresponding to the normal mode, a second icon corresponding to the low power mode, and a third icon corresponding to the accessories mode. The user may transition the vehicle 10 into the accessories mode by selecting the third icon. In some embodiments, the vehicle 10 is prevented from transitioning into the accessories mode until the user provides credentials that, when verified by the verification manager 608 (similar to the normal mode and the low power mode) indicate a sufficient level of authorization. In the accessories mode, the accessories 76 may be activated and controlled by the user (e.g., by interacting with the touch screen 62 or other buttons disposed on the accessories 76) but the driveline 50 is limited in operation. In particular, the accessories mode can be achieved by controlling the BMS 312 to allow the discharge of electrical energy from the battery modules 55 to the accessories 76, but limiting or preventing discharge of electrical energy from the battery modules 55 to the driveline 50. Advantageously, the touch screen 62 facilitates transition into the accessory mode (e.g., an accessory power mode) without requiring the use of a physical device such as a key.

Referring again to FIG. 6, which of the specific devices or which subset of the accessories 76 that are disabled in the low power mode may either be a predetermined profile, a user defined profile, or some combination thereof. For example, a default low power mode may be stored as a profile in which manufacturer-determined systems are disabled in the low power mode. However, the user may create or adjust new low power modes by creating or adjusting new profiles that include different subsets of the accessories 76 or devices that are disabled or deactivated in the various new low power modes. For example, if the user desires for a GPS system or a radio to be active even in the low power mode, the user may, through interaction at the touch screen 62 and entry of proper credentials, create a new low power mode that is similar to the default low power mode, but has the exception of allowing the discharge of electrical energy from the battery modules 55 to the GPS system or the radio. The user may also set the new low power mode to be a preferred mode that the vehicle 10 automatically transitions into after a period of inactivity (e.g., the time out or sleep features described in greater detail above with reference to step 506 of FIG. 7). The user may similarly define new profiles for adjusted accessory modes (e.g., an accessory mode where only an entertainment center or specific accessory is powered, but all other accessories and the driveline 50 are deactivated).

It should also be understood that the touch screen 62 through which the user transitions the vehicle 10 between the different power modes (e.g., the normal mode, the low power mode, the accessory mode, etc.) may be a digital device that is physically mounted on a dash board or instrument panel of the vehicle 10. Additionally or alternatively, the vehicle controller 100 may communicate with a personal computer device (e.g., a smart phone, a tablet, etc.) that includes a touch screen or other input device through which the user may be allowed to provide inputs (e.g., user requests) to transition the vehicle 10 between the different power modes on demand.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.), the site monitoring and control system 200 (e.g., the remote systems 240, the user portal 230, the user sensors 220, etc.), and the power system 300 as shown in the various exemplary embodiments is illustrative only. Additionally, any element disclosed in one embodiment may be incorporated or utilized with any other embodiment disclosed herein.

1. A golf cart comprising:
a user interface;
an electric motor;
one or more electric components;
a battery configured to provide electrical power to the electric motor and the one or more electric components; and
processing circuitry configured to:
operate the golf cart according to a first mode that permits operation of the electric motor to drive a tractive element without restricting operation of the one or more of the electric components;
responsive to receiving a user request at the user interface to transition the golf cart out of the first mode, transition the golf cart into a second mode in which an amount of power discharged from the battery to at least one of the one or more electric components is limited such that either (a) the at least one of the one or more electric components is restricted from receiving power from the battery or (b) the battery discharges a lesser amount of power than when the golf cart operates in the first mode.

2. The golf cart of claim 1, wherein the processing circuitry is configured to:
responsive to (a) not receiving the user request at the user interface to transition the golf cart out of the first mode and (b) an amount of elapsed time since previous operation of the golf cart reaching a threshold, transition the golf cart into the second mode; and
responsive to (a) not receiving the user request at the user interface to transition the golf cart out of the first mode and (b) the amount of elapsed time since previous operation of the golf cart being less than the threshold, maintain the golf cart in the first mode.

3. The golf cart of claim 1, wherein operating the golf cart according to the second mode includes permitting operation of the electric motor to drive the tractive element responsive to the control input while either (a) limiting the at least one of the one or more electric components from receiving power from the battery or (b) only allowing the at least one of the one or more electric components to receive the lower amount of power from the battery.

4. The golf cart of claim 1, wherein the processing circuitry is configured to prompt the user on the user interface to enter the second mode in response to detecting inactivity of the golf cart without requiring the user to navigate to a power saving selection interface with the user interface.

5. The golf cart of claim 1, wherein the processing circuitry is configured to transition the golf cart out of the second mode and back into the first mode responsive to activity at the user interface or operation of the golf cart.

6. The golf cart of claim 1, wherein the user interface includes a digital touch screen configured to obtain the user request responsive to a user touching the digital touch screen.

7. The golf cart of claim 1, wherein the processing circuitry is configured to:
receive a credential from a user via the user interface or a biometric sensor; and
restrict transitioning out of the first mode and into the second mode until the credential is authenticated.

8. The golf cart of claim 1, wherein the user request is a first user request, and wherein the processing circuitry is configured to:
receive a second user request; and
responsive to the second user request, transition the golf cart into a third mode where the electric motor is restricted from consuming power from the battery and at least one of the one or more electric components are allowed to consume power from the battery responsive to user commands to operate the one or more electric components.

9. A power control system for a vehicle, the power control system comprising:
processing circuitry configured to:
operate the vehicle according to a first mode that permits operation of an electric motor that consumes power from a battery to drive a tractive element without restricting operation of one or more electric components of the vehicle; and
responsive to receiving a user request at a user interface to transition the vehicle out of the first mode, transition the vehicle into a second mode in which an amount of power discharged from the battery to at least one of the one or more electric components is limited such that either (a) the at least one of the one or more electric components is restricted from receiving power from the battery or (b) the battery discharges a lesser amount of power than when the vehicle operates in the first mode.

10. The power control system of claim 9, wherein the processing circuitry is configured to:
responsive to (a) not receiving the user request at the user interface to transition the vehicle out of the first mode and (b) an amount of elapsed time since previous operation of the vehicle reaching a threshold, transition the vehicle into the second mode; and
responsive to (a) not receiving the user request at the user interface to transition the vehicle out of the first mode and (b) the amount of elapsed time since previous operation of the vehicle being less than the threshold, maintain the vehicle in the first mode.

11. The power control system of claim 9, wherein operating the vehicle according to the second mode includes permitting operation of the electric motor to drive the tractive element responsive to the control input while either (a) limiting the at least one of the one or more electric components from receiving power from the battery or (b) only allowing the at least one of the one or more electric components to receive the lower amount of power from the battery.

12. The power control system of claim 9, wherein the processing circuitry is configured to prompt the user on the user interface to enter the second mode in response to detecting inactivity of the vehicle without requiring the user to navigate to a power saving selection interface with the user interface.

13. The power control system of claim 9, wherein the processing circuitry is configured to transition the vehicle out of the second mode and back into the first mode responsive to activity at the user interface or operation of the vehicle.

14. The power control system of claim 9, wherein the user interface includes a digital touch screen configured to obtain the user request responsive to a user touching the digital touch screen.

15. The power control system of claim 9, wherein the processing circuitry is configured to:
receive a credential from a user via the user interface or a biometric sensor; and
restrict transitioning out of the first mode and into the second mode until the credential is authenticated.

16. The power control system of claim 9, wherein the user request is a first user request, and wherein the processing circuitry is configured to:
receive a second user request; and
responsive to the second user request, transition the vehicle into a third mode where the electric motor is restricted from consuming power from the battery and at least one of the one or more electric components are allowed to consume power from the battery responsive to user commands to operate the one or more electric components.

17. A method of transitioning a vehicle between, and operating the vehicle according to, different modes of power consumption, the method comprising:
operating the vehicle according to a first mode that permits operation of an electric motor that consumes power from a battery to drive a tractive element without restricting operation of one or more electric components of the vehicle that consume power from the battery; and
responsive to receiving a user request at a user interface to transition the vehicle out of the first mode, transitioning the vehicle into a second mode in which an amount of power discharged from the battery to at least one of the one or more electric components is limited such that either (a) the at least one of the one or more electric components is restricted from receiving power from the battery or (b) the battery discharges a lesser amount of power than when the vehicle operates in the first mode.

18. The method of claim 17, further comprising:
responsive to (a) not receiving the user request at the user interface to transition the vehicle out of the first mode and (b) an amount of elapsed time since previous operation of the vehicle reaching a threshold, transition the vehicle into the second mode; and
responsive to (a) not receiving the user request at the user interface to transition the vehicle out of the first mode and (b) the amount of elapsed time since previous operation of the vehicle being less than the threshold, maintain the vehicle in the first mode.

19. The method of claim 17, wherein operating the vehicle according to the second mode includes permitting operation of the electric motor to drive the tractive element responsive to the control input while either (a) limiting the at least one of the one or more electric components from receiving power from the battery or (b) only allowing the at least one of the one or more electric components to receive the lower amount of power from the battery.

20. The method of claim 17, wherein the method includes prompting the user on the user interface to enter the second mode in response to detecting inactivity of the vehicle without requiring the user to navigate to a power saving selection interface with the user interface.
